(19) United States
(12) Patent Application Publication
(10) Pub. No.: US 2024/0014654 A1
(43) Pub. Date: Jan. 11, 2024

(54) POWER DISTRIBUTION SYSTEM, POWER TRANSACTION SYSTEM, AND POWER SYSTEM OPERATING SYSTEM

(71) Applicant: KABUSHIKI KAISHA TOSHIBA, Tokyo (JP)

(72) Inventor: Tetsu SHIJO, Setagaya Tokyo (JP)

(73) Assignee: KABUSHIKI KAISHA TOSHIBA, Tokyo (JP)

(21) Appl. No.: 18/184,883

(22) Filed: Mar. 16, 2023

(30) Foreign Application Priority Data
Jul. 11, 2022 (JP) 2022-111307

(51) Int. Cl. H02J 3/14

(52) U.S. Cl. CPC H02J 3/14; H02J 2310/60

(57) ABSTRACT

According to one embodiment, a power distribution system includes switchgear units. The switchgear units are interposed between a feeder and power distribution areas. Each of the switchgear unit cuts off a power supply path when a frequency of power on the feeder falls below the allowable frequency in a case where the allowable frequency has been set, cuts off the power supply path when a frequency change rate of power on the feeder exceeds the allowable frequency change rate in a case where the allowable frequency change rate has been set, and cuts off the power supply path when an elapsed time since a state in which the power supply path between the feeder and the power distribution area is to be cut off is formed exceeds the allowable response time in a case where the allowable response time has been set.

### CROSS-REFERENCE TO RELATED APPLICATIONS

This application is based upon and claims the benefit of priority from Japanese Patent Applications No. 2022-111307, filed Jul. 11, 2022, the entire contents of which are incorporated herein by reference.

### FIELD

Embodiments described herein relate generally to a power distribution system, a power transaction system, and a power system operating system.

### BACKGROUND

There is a load shedding system that cuts off power supply to a power distribution area connected to a feeder by an under frequency relay (UFR) installed for each feeder of a substation in a power system when supply and demand become tight even after a power saving request such as a demand response due to a sudden change in temperature or an unplanned stop of a large power plant so that the system stability deteriorates.

Further, when the supply and demand is tight, it is also examined to divide the power distribution area into several groups and perform a planned power outage before a system power outage.

In a case where set values (for example, frequencies) at which under frequency relays installed in a plurality of substations operate are set to be the same, loads are simultaneously shed in the plurality of substations when the frequency is greatly reduced due to a system accident, a disaster, or the like. Then, there is a problem that the power supply exceeds the demand, the system frequency rises more than expected, and an over frequency relay (OFR) of the power plant operates to cause the system power outage.

Further, UFRs with a frequency change rate element (df/dt) function also operate at the same time when set values are the same. Then, there is a problem that the power supply exceeds the demand, the system frequency rises more than expected, and the over frequency relay (OFR) of the power plant operates to cause the system power outage.

Further, the planned power outage based on the grouping also has a problem that the planned power outage is not performed in time due to unexpected supply and demand tightness due to a disaster or the like.

### BRIEF DESCRIPTION OF THE DRAWINGS

FIG. 1 is a diagram schematically illustrating an overall image of a power distributing mechanism through which power is supplied from a power generation utility (or an electricity retailer) to a consumer.

FIG. 2 is a diagram illustrating an example of a configuration of a power distribution system according to an embodiment.

FIG. 3 is a diagram illustrating a first setting example of operation conditions of switchgear units in the power distribution system according to the embodiment.

FIG. 4 is a diagram illustrating a second setting example of the operation conditions of the switchgear units in the power distribution system according to the embodiment.

FIG. 5 is a diagram illustrating a third setting example of the operation conditions of the switchgear units in the power distribution system according to the embodiment.

FIG. 6 is a diagram for describing an example in which the power distribution system according to the embodiment shifts operation timings of the switchgear units among a plurality of consumers.

FIG. 7 is a diagram for describing an assignment example of priority orders used in the power distribution system according to the embodiment.

FIG. 8 is a diagram illustrating an example of a formation of a microgrid of the power distribution system according to the embodiment.

### DETAILED DESCRIPTION

Embodiments will be described hereinafter with reference to the accompanying drawings.

In general, according to one embodiment, a power distribution system includes a plurality of switchgear units and a power system operating system. The plurality of switchgear units are interposed between a feeder connected to a substation and a plurality of power distribution areas. The power system operating system that is capable of communicating with the plurality of switchgear units and is configured to control power supply to the plurality of power distribution areas via the plurality of switchgear units. The power system operating system is configured to set any one of an allowable frequency, an allowable frequency change rate, and an allowable response time for at least two switchgear units among the plurality of switchgear units based on priority orders assigned to the plurality of power distribution areas. Each of the at least two switchgear units: cuts off a power supply path between the feeder and the power distribution area when a frequency of power on the feeder falls below the allowable frequency in a case where the allowable frequency has been set; cuts off the power supply path between the feeder and the power distribution area when a frequency change rate of power on the feeder exceeds the allowable frequency change rate in a case where the allowable frequency change rate has been set; and cuts off the power supply path between the feeder and the power distribution area when an elapsed time since a state in which the power supply path between the feeder and the power distribution area is to be cut off is formed exceeds the allowable response time in a case where the allowable response time has been set. An absolute value of a difference between the allowable frequency and a reference frequency is larger as the priority order is higher. The allowable frequency change rate is higher as the priority order is higher. The allowable response time is longer as the priority order is higher.

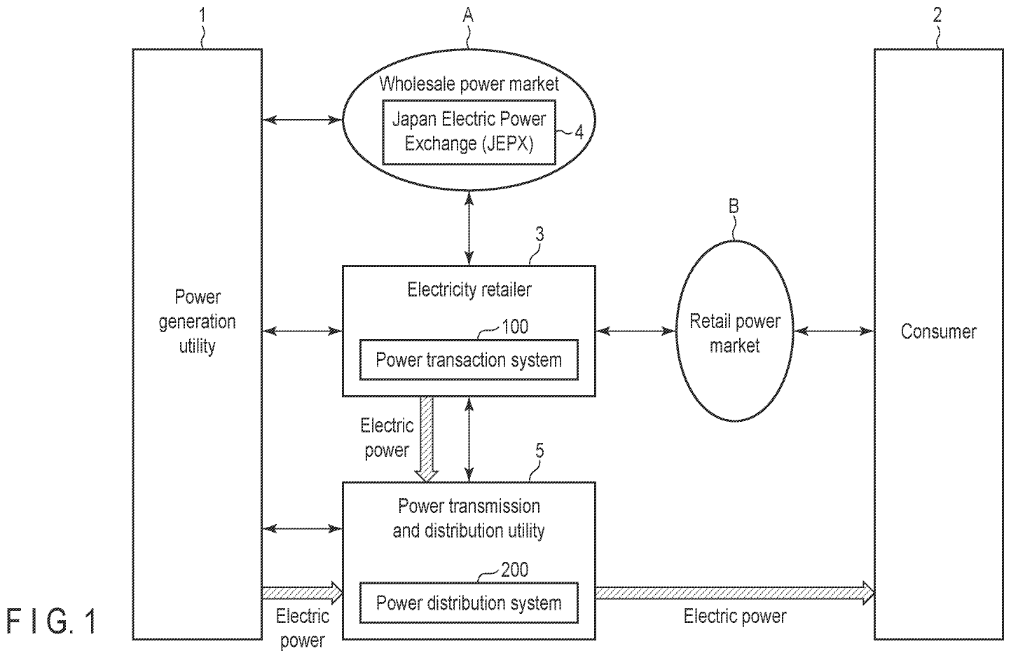

First, a power distributing mechanism in which power is supplied from a power generation utility 1 (or electricity retailer 3) to a consumer 2 will be roughly described with reference to FIG. 1.

The electricity retailer 3 and a power transmission and distribution utility 5 are interposed between the power generation utility 1 and a consumer 2. The power transmission and distribution utility 5 includes a power transmission utility, a specified power transmission and distribution utility, and the like in addition to a general power transmission and distribution utility. A wholesale power market A is formed as a market in which the power generation utility 1 and the electricity retailer 3 trade power. The wholesale power market A is operated by Japan Electric Power Exchange (JEPX) 4. Further, a retail power market B is formed as a market in which the electricity retailer 3 and the consumer 2 trade power. The retail power market B is an abstract market in which there is no official exchange such as the JEPX 4 in the wholesale power market A. Further, the power generation utility 1 and the electricity retailer 3 may perform a relative transaction under a relative contract. The electricity retailer 3 sometimes pays a wheeling charge to the power transmission and distribution utility 5 to supply power to the consumer 2. In FIG. 1, thin-line arrows in both directions connecting two parties, such as between the power generation utility 1 and the electricity retailer 3 and between the electricity retailer 3 and the power transmission and distribution utility 5, indicate transaction relationships.

The consumer 2 can arbitrarily select the electricity retailer 3 from among a plurality of the electricity retailers 3 and can make an electricity supply and demand contract. For example, the consumer 2 can freely select a contract plan from among a wide variety of contract plans by referring to, comparing, and examining the contract plans provided by the plurality of electricity retailers 3 via the Internet, and taking into consideration the expected power consumption, cost, and the like. That is, the consumer 2 is one contractor who makes an electricity supply and demand contract with a certain electricity retailer 3. The electricity retailer 3 includes a power transaction system 100 configured to acquire the electricity supply and demand contract from the consumer 2 in the retail power market B or to provide after-sales service to the consumer 2 who has made the electricity supply and demand contract. The power transaction system 100 is achieved by, for example, a computer called a server or the like.

In order to stably supply power to the consumer 2 making the electricity supply and demand contract, the electricity retailer 3 makes an electricity supply and demand contract with the power generation utility 1 via the wholesale power market A. For example, the electricity retailer 3 can purchase, from the power generation utility 1, a shortage of power that needs be supplied to the consumer 2, the shortage that is hardly covered by its own power generation facility, or can sell a surplus to the power generation utility 1.

Further, the power generation utility 1 and the electricity retailer 3 make a wheeling contract with the power transmission and distribution utility 5. The power transmission and distribution utility 5 transmits power from the power generation utility 1 and the electricity retailer 3 to the consumer 2 based on the wheeling contract. The power transmission and distribution utility 5 includes a power distribution system 200 configured to control such power transmission. The power distribution system 200 is achieved by, for example, a computer called a server or the like.

Since the above distributing mechanism is formed, the balance of power supply and demand between the power generation utility 1 and the electricity retailer 3, and the consumer 2 is maintained.

However, for example, in a case where the amount of power demand drastically increases due to a sudden change in temperature or the amount of power supply drastically decreases due to a disaster, there is a possibility that the amount of power demand exceeds the amount of power supply without being prevented by the above-described adjustment using the distributing mechanism in time. When the balance of power supply and demand suddenly collapses (when power shortage occurs suddenly), there is a possibility that a planned power outage is not performed in time. At that time, if mechanisms (for example, under frequency relays (UFR)) for protecting the system operate simultaneously, the worst situation such as a system power outage is likely to be caused.

Therefore, the power transaction system 100 and the power distribution system 200 cooperate to rationally control the under frequency relay (UFR) in order to avoid such a situation in the present embodiment. Hereinafter, this point will be described in detail.

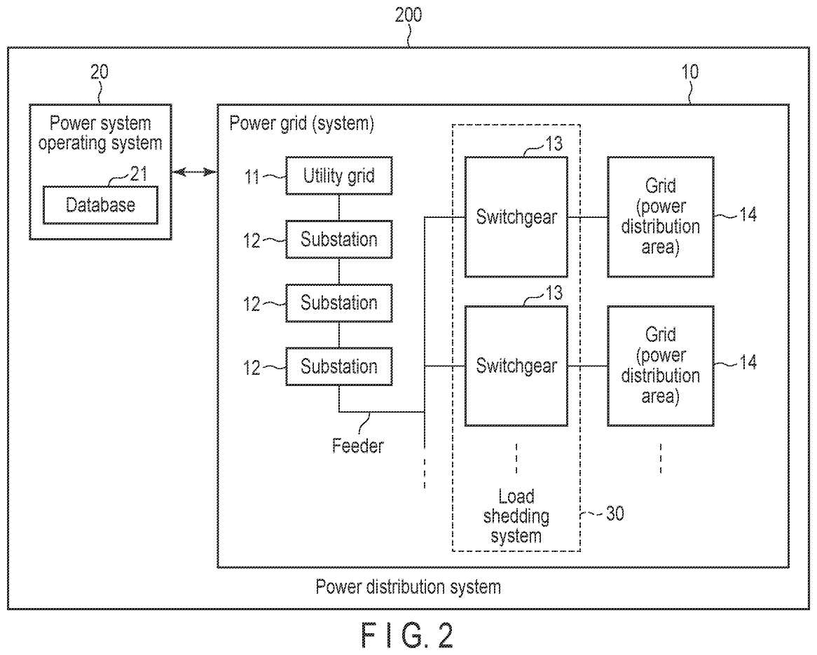

FIG. 2 is a diagram illustrating an example of a configuration of the power distribution system 200.

As illustrated in FIG. 2, the power distribution system 200 includes a power grid 10 called a system or the like, and a power system operating system 20 that integrally manages the operation of the power grid 10. The power system operating system 20 can communicate with various facilities (including at least a switchgear unit 13 to be described later) in the power grid 10. The power system operating system is achieved by, for example, a computer called a server or the like.

The power grid 10 efficiently transmits power from the power generation utility 1 or the electricity retailer 3 to the consumers 2 scattered in a wide range by gradually lowering the voltage from a utility grid 11 which is a long-distance power transmission line at the highest voltage through a plurality of hierarchically installed substations 12. A grid 14 is, for example, one power distribution area grouped for each geographical range. Each of the grids 14 includes a plurality of the consumers 2. In other words, each of the consumers 2 belongs to any of the grids 14.

The switchgear unit 13 is installed between a feeder extending from the substation 12 and each of the grids 14. The switchgear unit 13 cuts off a power supply path from the feeder to the grid 14 when a set operation condition is satisfied. The switchgear unit 13 is, for example, an under frequency relay (UFR). That is, the power grid 10 includes a load shedding system 30 capable of disconnecting a load (demand) for each of the grids 14. Note that the switchgear unit 13 is not necessarily installed for all the grids 14. For example, the grid 14 including a medical institution or an important public institution may be excluded from a target of a planned power outage, and may be placed outside the load shedding system 30.

The power system operating system 20 includes a database 21. The database 21 stores priority orders assigned to the plurality of grids 14. Then, the power system operating system 20 sets operation conditions of a plurality of the switchgear units 13 based on the priority orders stored in the database 21.

Specifically, the power system operating system 20 notifies each of the plurality of switchgear units 13 of a set value of the operation condition. The assignment of the priority order will be described later.

The power system operating system 20 sets the operation conditions of the plurality of switchgear units 13 such that the power supply is cut off in order from the grid 14 with a lower priority order when power shortage that is likely to lead to the system power outage occurs. As a result, it is possible to prevent a situation in which all of the plurality of switchgear units 13 operate simultaneously to cause the system power outage in the present embodiment.

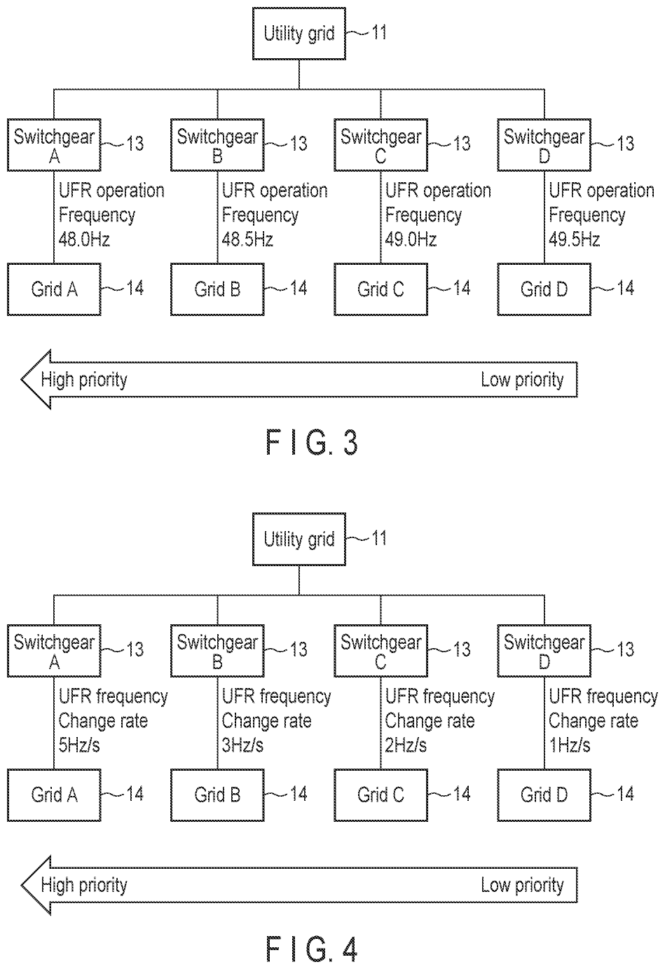

FIG. 3 is a diagram illustrating a first setting example of the operation conditions of the switchgear units 13. Note that the substation 12 is not illustrated in FIG. 3 for easy understanding.

Here, it is assumed that higher priorities (priority orders) are given in order of a grid “A” 14, a grid “B” 14, a grid “C” 14, and a grid “D” 14 (A>B>C>D). Here, it is assumed that a frequency of power on the feeder is about 50 Hz when the balance of power supply and demand is maintained.

When the amount of power demand exceeds the amount of power supply due to an increase in the amount of power demand or a decrease in the amount of power supply, the frequency of power on the feeder decreases. Focusing on such a phenomenon, the power system operating system 20 sets the operation conditions of the switchgear units 13 based on the priority orders given to the respective grids 14. For example, the power system operating system 20 notifies a switchgear unit “A” 13 interposed between the feeder and the grid “A” 14 of the lowest 48.0 Hz among all the switchgear units 13 as a set value of the operation condition. The switchgear unit “A” 13 sets 48.0 Hz notified from the power system operating system 20 as a threshold. The power system operating system 20 notifies the switchgear unit “B” 13 interposed between the feeder and the grid “B” 14 of the next lowest 48.5 Hz as a set value of the operation condition. Similarly, the power system operating system 20 notifies the switchgear unit “C” 13 interposed between the feeder and the grid “C” 14 of 49.0 Hz as a set value of the operation condition, and notifies the switchgear unit “D” 13 interposed between the feeder and the grid “D” 14 of the highest 49.5 Hz among all the switchgear units 13 as a set value of the operation condition.

In a case where the frequency of power on the feeder decreases due to the fact that the amount of power demand exceeds the amount of power supply under a state in which such a setting has been made, first, the operation condition set for the switchgear unit “D” 13 is satisfied at a point in time when the frequency decreases to 49.5 Hz so that the switchgear unit “D” 13 operates. As a result, a power supply path from the feeder to the grid “D” 14 is cut off. In other words, the consumer 2 belonging to the grid “D” 14 is disconnected from the power grid 10.

When the consumer 2 belonging to the grid “D” 14 is disconnected from the power grid 10, the demand for power disappears by such an extent, and thus, there is a possibility that the power shortage may be resolved. On the other hand, when the state in which the amount of power demand exceeds the amount of power supply continues and the frequency of power on the feeder further decreases, the operation condition set for the switchgear unit “C” 13 is satisfied at a point in time when the frequency decreases to 49.0 Hz so that the switchgear unit “C” 13 operates. As a result, a power supply path from the feeder to the grid “C” 14 is cut off, and the consumer 2 belonging to the grid “C” 14 is disconnected from the power grid 10. Similarly, when the state in which the amount of power demand exceeds the amount of power supply continues and the frequency of power on the feeder further decreases, the switchgear units 13 operate in ascending order of the priority order (B→A).

In this manner, the power system operating system 20 can set the operation conditions of the switchgear units 13 such that the power supply is cut off in order from the grid 14 with a lower priority order.

Although FIG. 3 illustrates an example in which different frequencies are set for all of the plurality of switchgear units 13, respectively, the same frequency may be set for two or more switchgear units 13 by assigning the same priority order. For example, the plurality of switchgear units 13 may be divided into three groups such as “priority: high”, “priority: medium”, and “priority: low” by assigning any priority order of 1 to 3 to the plurality of switchgear units 13.

Meanwhile, an example of using an event in which the frequency of power on the feeder decreases when the amount of power demand exceeds the amount of power supply and the power becomes insufficient has been described here. The amount of power supply may exceed the amount of power demand in a certain layer depending on a connection form of a generator in the system to which the substations are hierarchically connected. When power is left, the frequency of power on the feeder increases contrary to the above example. When power becomes excessive, an event called reverse power flow occurs in which the excessive power is transmitted from the substation to a higher-level power transmission network. In a case where the switchgear unit 13 configured to cut off the reverse power flow is to be installed, a frequency (a value higher than that in a normal state) as the set value of the operation condition may be changed and set for each of the substations.

FIG. 4 is a diagram illustrating a second setting example of operation conditions of the switchgear units 13. In the first setting example described with reference to FIG. 3, the frequency is set as a set value of the operation condition of the switchgear unit 13. On the other hand, in the second setting example illustrated in FIG. 4, a frequency change rate is set as a set value of the operation condition of the switchgear unit 13.

For example, when an abnormality of a generator is detected by a protective device or the like and the generator is disconnected from the power grid 10 in an emergency measure, the frequency of power on the feeder changes. The change in the frequency increases as a ratio of the amount of power generated by the generator to the amount of power supply increases. That is, the greater the frequency changes, the greater the influence of the amount of lost power on the system. Focusing on this point, in the second setting example, the frequency change rate is set as the set value of the operation condition of the switchgear unit 13, and the power system operating system 20 sets the operation condition of each of the switchgear units 13 based on a priority order given to each of the grids 14.

Here, it is also assumed that higher priorities (priority orders) are given in order of the grid “A” 14, the grid “B” 14, the grid “C” 14, and the grid “D” 14. For example, the power system operating system 20 notifies the switchgear unit “A” 13 interposed between the feeder and the grid “A” 14 of the highest 5 Hz among all the switchgear units 13 as the set value of the operation condition. The power system operating system 20 notifies the switchgear unit “B” 13 interposed between the feeder and the grid “B” 14 of the next highest 3 Hz as the set value of the operation condition. Similarly, the power system operating system 20 notifies the switchgear unit “C” 13 interposed between the feeder and the grid “C” 14 of 2 Hz as the set value of the operation condition, and notifies the switchgear unit “D” 13 interposed between the feeder and the grid “D” 14 of the lowest 1 Hz among all the switchgear units 13 as the set value of the operation condition.

Under a state in which such a setting has been made, for example, even in a case where the frequency of power on the feeder changes due to occurrence of disconnection of a generator, which has served as a part of power supply, from the system, none of the operation conditions set for the switchgear units “A” 13 to “D” 13 are satisfied so that power supply paths from the feeder to the grids are not cut off if a ratio of the amount of power generated by the generator to the amount of power supply is small and the frequency change rate does not reach 1 Hz/S.

As described above, the change in the frequency of the power on the feeder increases as the ratio of the amount of power generated by the generator disconnected from the system to the amount of power supply increases. When the frequency change rate reaches 1 Hz/S, the operation condition set for the switchgear unit “D” 13 is satisfied so that the switchgear unit “D” 13 operates. As a result, a power supply path from the feeder to the grid “D” 14 is cut off. In other words, the consumer 2 belonging to the grid “D” 14 is disconnected from the power grid 10.

When the frequency change rate reaches 2 Hz/S, the operation conditions set for the switchgear unit “C” 13 and the switchgear unit “D” 13 are satisfied so that the switchgear unit “C” 13 and the switchgear unit “D” 13 operate. As a result, the power supply paths from the feeder to the grid “C” 14 and the grid “D” 14 are cut off. In other words, the consumers 2 belonging to the grid “C” 14 and the grid “D” 14 are disconnected from the power grid 10. Similarly, the switchgear units “B” 13 to “D” 13 operate when the frequency change rate reaches 3 Hz/S, and the switchgear units “A” 13 to “D” 13 operate when the frequency change rate reaches 5 Hz/S.

In this manner, the power system operating system 20 can set the operation conditions of the switchgear units 13 such that the power supply is cut off in order from the grid 14 having the lower priority order according to the degree of influence of the amount of lost power supply.

Similarly to the frequency in FIG. 3, FIG. 4 also illustrates an example in which different frequency change rates are set for all of the plurality of switchgear units 13, but the same frequency change rate may be set for two or more switchgear units 13.

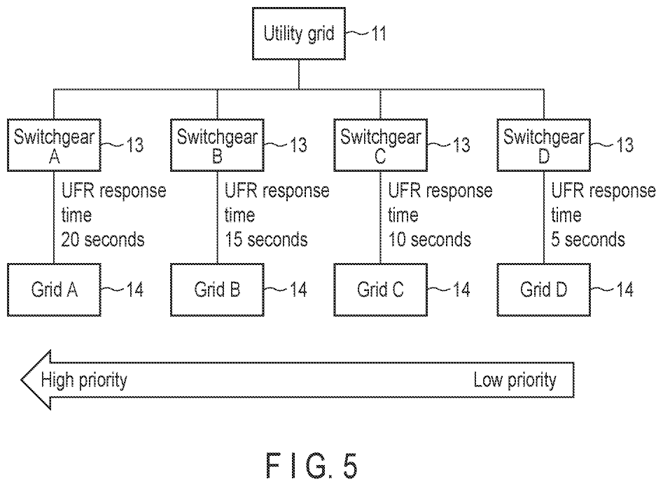

FIG. 5 is a diagram illustrating a third setting example of operation conditions of the switchgear units 13. Here, it is assumed that the frequency of the first setting example described with reference to FIG. 3 is set as the operation conditions of all the switchgear units 13. The same value is set for all the switchgear units 13. In addition, in the third setting example illustrated in FIG. 5, a response time until a power supply path is actually cut off since the frequency of power on the feeder falls below a threshold is set as a set value of the operation condition of the switchgear unit 13.

Here, it is also assumed that higher priorities (priority orders) are given in order of the grid “A” 14, the grid “B” 14, the grid “C” 14, and the grid “D” 14. For example, the power system operating system 20 notifies the switchgear unit “A” 13 interposed between the feeder and the grid “A” 14 of the longest 20 seconds among all the switchgear units 13 as the set value of the operation condition. The power system operating system 20 notifies the switchgear unit “B” 13 interposed between the feeder and the grid “B” 14 of the next longest 15 seconds as the set value of the operation condition. Similarly, the power system operating system 20 notifies the switchgear unit “C” 13 interposed between the feeder and the grid “C” 14 of 10 seconds as the set value of the operation condition, and notifies the switchgear unit “D” 13 interposed between the feeder and the grid “D” 14 of the shortest 5 seconds among all the switchgear units 13 as the set value of the operation condition.

Under such a condition, it is assumed that a decrease in the frequency of power on the feeder occurs due to the amount of power demand exceeding the amount of power supply and the frequency decreases until falling below the thresholds at which the switchgear unit “A” 13 to the switchgear unit “D” 13 are to operate. Then, in each of the switchgear units “A” 13 to “D” 13, counting of the response time is started, and the counting is continued while the frequency remains below the threshold. Then, first, the operation condition set for the switchgear unit “D” 13 is satisfied at a point in time when the counting is performed up to 5 seconds so that the switchgear unit “D” 13 operates. As a result, a power supply path from the feeder to the grid “D” 14 is cut off. In other words, the consumer 2 belonging to the grid “D” 14 is disconnected from the power grid 10.

When the consumer 2 belonging to the grid “D” 14 is disconnected from the power grid 10, the demand for power disappears by such an extent, and thus, there is a possibility that the power shortage may be resolved. On the other hand, if a state in which the amount of power demand exceeds the amount of power supply continues thereafter and the counting proceeds to 10 seconds with the frequency of power on the feeder remaining below the threshold, the operation condition set for the switchgear unit “C” 13 is satisfied so that the switchgear unit “C” 13 operates. As a result, a power supply path from the feeder to the grid “C” 14 is cut off, and the consumer 2 belonging to the grid “C” 14 is disconnected from the power grid 10. Similarly, if a state in which the amount of power demand exceeds the amount of power supply continues and the counting proceeds with the frequency of power on the feeder remaining below the threshold, the switchgear units 13 operate in ascending order of the priority order (B→A).

In this manner, the power system operating system 20 can set the operation conditions of the switchgear units 13 such that the power supply is cut off in order from the grid 14 with a lower priority order.

Note that the power system operating system applies the above-described first to third setting examples exclusively and selectively to the entire system. That is, there is no case where the power system operating system 20 applies the frequency to a certain switchgear unit 13 and does not apply the frequency change rate to another switchgear unit 13 as the operation conditions for shifting operation timings of the switchgear units 13. However, the power system operating system 20 can switch the first setting example to the third setting example as the entire system such that the frequency is applied at a certain point in time and the frequency change rate is applied at another point in time.

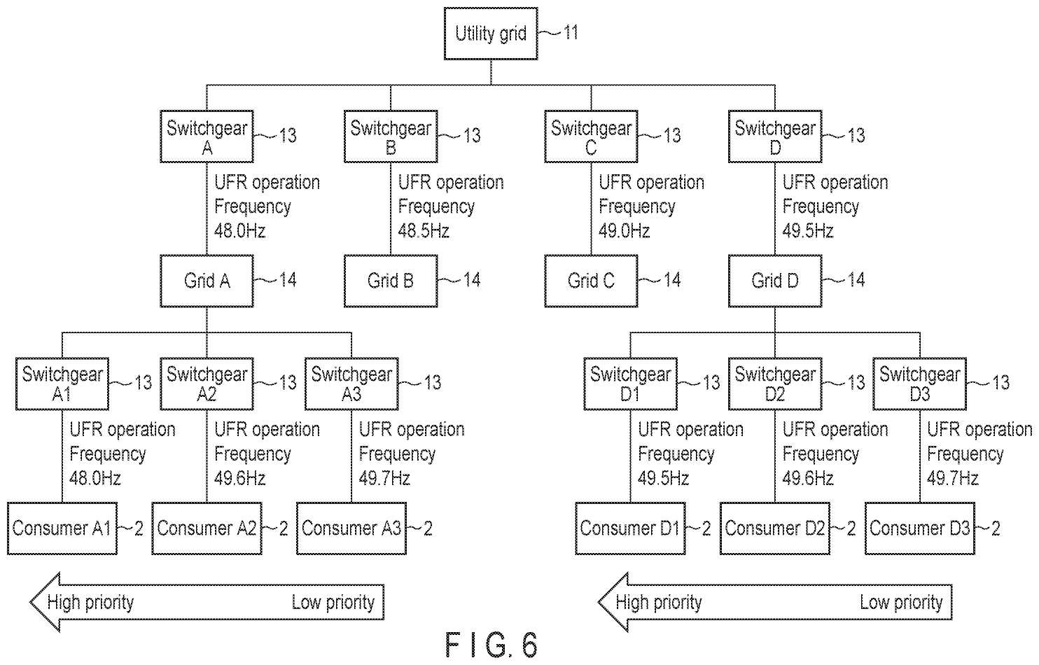

Next, an example of shifting operation timings of the switchgear units 13 among the plurality of consumers 2 in addition to shifting the operation timings of the switchgear units 13 among the plurality of grids 14 will be described with reference to FIG. 6.

In FIGS. 3 to 5, it is assumed that the power supply is cut off in units of the grids 14 for easy understanding of the description. That is, the power supply to all the consumers 2 in one grid 14 is cut off simultaneously. On the other hand, in FIG. 6, it is assumed that timings at which power supply is cut off are different among the consumers 2 even in one grid 14.

Specifically, in this example, not only the switchgear units “A” 13 to “D” 13 are installed between the feeder extending from the substation and the respective grids 14 but also switchgear units “A1” 13 to “A3” 13 and switchgear units “D1” 13 to “D3” 13 are installed between power supply paths guided into the grid 14 and the respective consumers 2.

Here, it is assumed that higher priorities (priority orders) are given in order of a consumer “A1” 2, a consumer “A2” 2, and a consumer “A3” 2 in the grid “A” 14, and higher priorities are given in order of a consumer “D1” 2, a consumer “D2” 2, and a consumer “D3” 2 in the grid “D” 14. Here, it is further assumed that the frequency described with reference to FIG. 3 is applied as the operation condition for shifting the operation timing of the switchgear unit 13.

For example, the power system operating system 20 notifies the switchgear unit “A1” 13 of 48.0 Hz as a set value of the operation condition, notifies the switchgear unit “A2” 13 of 49.6 Hz as a set value of the operation condition, and notifies the switchgear unit “A3” 13 of 49.7 Hz as a set value of the operation condition. Further, the power system operating system 20 notifies the switchgear unit “D1” 13 of 49.5 Hz as a set value of the operation condition, notifies the switchgear unit “D2” 13 of 49.6 Hz as a set value of the operation condition, and notifies the switchgear unit “D3” 13 of 49.7 Hz as a set value of the operation condition.

Under a state in which such a setting has been made, if an increase in the amount of power demand or a decrease in the amount of power supply occurs so that the amount of power demand exceeds the amount of power supply and the frequency of power on the feeder decreases, the operation condition set for the switchgear unit “D” 13 is satisfied at a point in time when the frequency decreases to 49.5 Hz so that the switchgear unit “D” 13 operates as described with reference to FIG. 3. Further, the operation condition set for the switchgear unit “A” 13 is satisfied at a point in time when the frequency decreases to 48.0 Hz so that the switchgear unit “A” 13 operates.

On the other hand, when the operation conditions set for the switchgear unit “A3” 13 of the grid “A” 14 and the switchgear unit “D3” 13 of the grid “D” 14 are satisfied at a point in time when the frequency decreases to 49.7 Hz, and thus, power supply to the consumer “A3” 2 and the consumer “D3” 2 is cut off. Even when power demand from the consumer “A3” 2 and the consumer “D3” 2 disappears, the power shortage is not resolved, and if the frequency of power continues to decrease, the operation conditions of the switchgear unit “A2” 13 of the grid “A” 14 and the switchgear unit “D2” 13 of the grid “D” 14 are satisfied at a point in time when the frequency decreases to 49.6 Hz so that power supply to the consumer “A2” 2 and the consumer “D2” 2 is cut off. Similarly, power supply to the consumer “D1” 2 is cut off if the frequency of power continues to decrease so that the frequency decreases to 49.5 Hz, and power supply to the consumer “A1” 2 is cut off if the frequency of power further continues to decrease so that the frequency decreases to 48.0 Hz.

In this manner, the power system operating system 20 can gradually cut off the power supply based on the priority order for each of the consumers 2 having a finer granularity than the grid 14. That is, it is possible to cut off the power supply starting from the consumer 2 with a lower priority order ((A3, D3)→(A2, D2)→D1→A1).

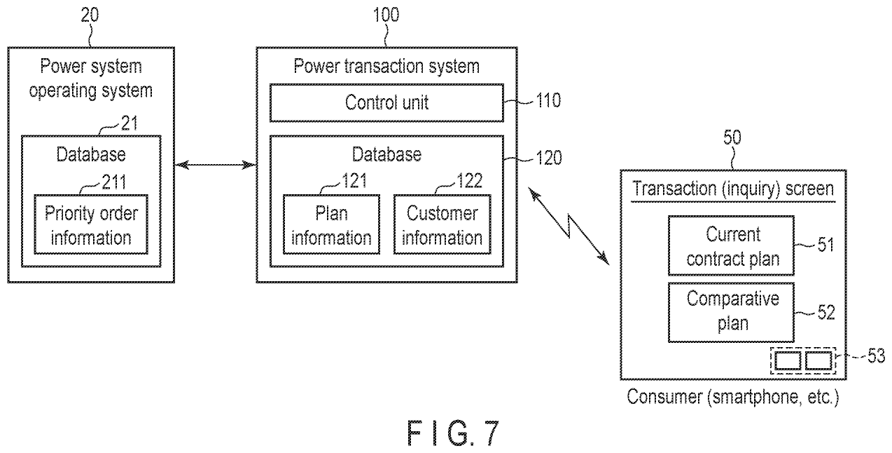

Here, an example of assigning priority orders to the plurality of grids 14 (and the plurality of consumers 2) will be described with reference to FIG. 7.

The power transaction system 100 of the electricity retailer 3 includes a control unit 110 and a database 120. The database 120 stores plan information 121 and customer information 122.

For example, the control unit 110 generates and transmits an HTML file configured to display a transaction (inquiry) screen 50 as illustrated in FIG. 7 on a smartphone of the consumer 2 in response to a request via the Internet from a browser operating on the smartphone. On the transaction (inquiry) screen 50, for example, a current contract plan 51 and a comparative plan 52 are presented together with operation buttons 53. Note that the transaction (inquiry) screen 50 illustrated in FIG. 7 is a screen for the consumer 2 who has already made the electricity supply and demand contract with the electricity retailer 3, and the control unit 110 generates and transmits a HTML file for the transaction (inquiry) screen on which recommended plans and the like are presented for the new consumer 2.

Contract plans include, for example, a plan in which power supply is likely to be cut off when power shortage occurs but a charge is inexpensive, and a plan in which power supply is less likely to be cut off but a charge is expensive. The control unit 110 obtains the current contract plan 51 from the customer information 122 in the database 120, and obtains the comparative plan 52 from the plan information 121 in the database 120.

The power transaction system 100 presents the current contract plan 51 and the comparative plan 52, thereby enabling the consumer 2 to examine switching of the plan and take a procedure therefor. In the case of the new consumer 2, if there is a desired plan among the recommended plans, a contract procedure for the plan can be taken. For example, it is conceivable that the consumer 2 including a power generation facility and a power storage facility selects the plan in which the power supply is likely to be cut off but the charge is inexpensive.

The control unit 110 stores information of the consumer 2 including the electricity supply and demand contract (plan) with the consumer 2 in the database 120 as the customer information 122. The control unit 110 determines a priority order of the consumer 2 or the grid 14 to which the consumer 2 belongs based on the customer information 122 including the plan contracted by the consumer 2. The control unit 110 notifies the power system operating system 20 of the determined priority order. The control unit 110 may acquire the priority order from the power system operating system 20 and present (disclose) the priority order to the consumer 2 through the transaction (inquiry) screen 50 when generating the transaction (inquiry) screen 50. In other words, the power system operating system 20 may have a function of transmitting the priority order notified at the time of the determination described above to the power transaction system 100 in response to a request from the power transaction system 100. For example, the control unit 110 may present a priority order in the current contract plan 51 and a priority order in the comparative plan 52 together on the transaction (inquiry) screen 50. When the priority orders are visualized (for example, disclosed via the Internet) in this manner, the consumer 2 can examine switching of the plan in consideration of the presented priority orders.

The power system operating system 20 stores the priority order received from the power transaction system 100 in the database 21 (as priority order information 211). The power system operating system 20 notifies the switchgear unit 13 in the power grid 10 of a set value of an operation condition based on the priority order information 211.

The control unit 110 of the power transaction system 100 may further determine priority orders of the grids 14 based on contract plans of the consumers 2. For example, various methods can be adopted as a method for determining the priority orders of the grids 14, such as setting a higher priority order as an average value of a power purchase price (by the consumer 2) determined in a plan contracted by the consumer 2 in the grid 14 is higher, or setting a higher priority order as a maximum value of the power purchase price in the grid 14 is higher.

Alternatively, the control unit 110 of the power transaction system 100 may determine priority orders of the grids 14 in advance, and determine any grid 14 to which a consumer 2 is to belong according to a power purchase price when an electricity supply and demand contract is made with the consumer 2. For example, the plurality of grids 14 having different priority orders may be provided in an overlapping manner in the same geographical range to group a plurality of the consumers 2 in the same geographical range.

Furthermore, a plan provided by the power transaction system 100 to the consumer 2 may include a power purchase price from the consumer 2 in addition to a sale price (charge) to the consumer 2. For example, the price may be set such that a higher power purchase price is set for a plan in which power supply is less likely to be cut off when power shortage occurs. That is, as the priority order of the grid 14 increases, the power purchase price from the consumer 2 belonging to the grid 14 may be increased. Alternatively, in a case where priority orders are assigned in units of the consumers 2, the power purchase price from the consumer 2 may be increased as the consumer 2 is assigned with a higher priority order. Further, an electricity charge according to the priority order may be determined in terms in which a retailer sets the electricity charge and the like.

The power transmission and distribution utility 5 may set different wheeling charges among the priority orders of the grids 14. For example, a higher wheeling charge is set for a grid with a higher priority order. A higher electricity charge is set for a grid in which the power supply is less likely to be cut off.

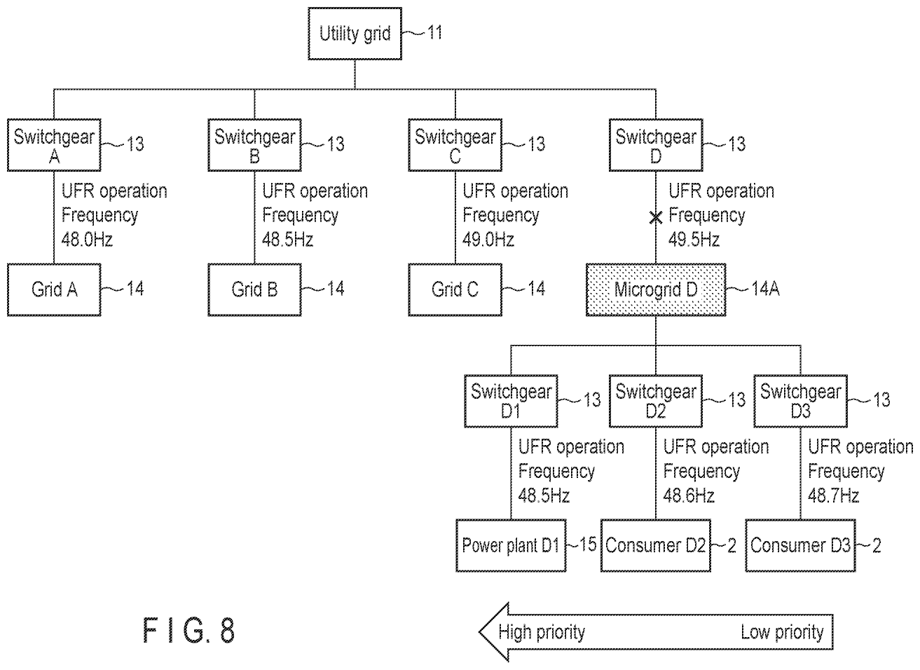

FIG. 8 is a diagram illustrating an example of a formation of a microgrid.

Here, it is assumed that a frequency of power on the feeder is below 49.5 Hz, an operation condition of the switchgear unit “D” 13 is satisfied, and power supply to the grid “D” 14 is cut off. At this time, the grid “D” 14 of the embodiment may transition to a microgrid 14A. Here, it is assumed that there is a power plant “D1” 15 in the grid “D” 14, and a local independent system (microgrid) is formed by power from the power plant. The local independent system is also referred to as an off-grid. The off-grid refers to a state of not being connected to the power grid 10 of the power transmission and distribution utility 5 or a state of being self-sufficient without depending on the power grid 10 of the power transmission and distribution utility 5. Note that the power plant 15 may be the consumer 2 that includes a power generation facility such as a solar panel and has a contract to make the electricity retailer 3 purchase surplus power equal to or more than power consumed by the consumer 2 itself. Alternatively, there may be a case where the power generation utility 1 or the electricity retailer 3 constructs the microgrid by supplying power to a specific consumer 2 using a line owned by the power generation utility 1 or the electricity retailer 3 itself in a form called specific supply or the like.

In this case, the switchgear unit “D2” 13 and the switchgear unit “D3” 13 are installed to disconnect the consumer 2 when it is difficult for the power plant “D1” 15 to cover power demand in the microgrid “D” 14A. The switchgear unit “D1” 13 is also installed to prevent power of the power plant “D1” 15 from being output to the microgrid “D” 14A, for example, for preservation of the power plant “D1” 15. Here, it is assumed that the frequency described with reference to FIG. 3 is applied as the operation condition for shifting an operation timing of the switchgear unit 13.

First, if the frequency of power of the power plant “D1” 15 falls below 48.7 Hz, the operation condition of the switchgear unit “D3” 13 is satisfied so that power supply to the consumer “D3” 2 is cut off. If the frequency of power continues to decrease even after power demand of the consumer “D3” 2 disappears and falls below 48.6 Hz, the operation condition of the switchgear unit “D2” 13 is satisfied so that power supply to the consumer “D2” 2 is cut off. Nevertheless, if the frequency of power continues to decrease (with power demand of the consumer 2 not illustrated) and falls below 48.5 Hz, the operation condition of the switchgear unit “D1” 13 is satisfied so that the power supply from the power plant “D1” 15 to the microgrid “D” 14A is cut off.

In this manner, it is possible to prevent a situation in which all of the plurality of switchgear units 13 simultaneously operate to cause the system power outage in the microgrid 14A as well in the present embodiment.

Recently, the number of the consumers 2 including the power generation facility or power storage facility has been increasing. This type of power generation facility or power storage facility includes an inverter configured for efficient operation. There are roughly two types of algorithms to which the inverter can be applied, that is, a current control type called a grid following inverter and a voltage control type called a grid forming inverter. The grid following inverter is an algorithm used as a conventional grid-connected inverter, and controls an output current of the inverter. On the other hand, the grid forming inverter is an algorithm for controlling an output voltage of the inverter, and can output a voltage from the inverter to supply power even during the system power outage.

Therefore, when the grid 14 transitions to the microgrid 14A (when the microgrid 14A is formed) as the power from the system is cut off by the switchgear unit 13 in the embodiment as described with reference to FIG. 8, the algorithm is switched to the grid forming inverter when there is an inverter to which the grid following inverter is applied in the power generation facility or the power storage facility in the grid 14.

Alternatively, both the grid following inverter and the grid forming inverter may include a virtual synchronous generator (VSG) that supplies a simulated inertial force as a function of supporting the system. The VSG is an algorithm of a simulated inertia control type. In a case where the VSG is provided, a transition from the algorithm of the VSG having no simulated inertia may be made to the algorithm having the simulated inertia in the grid following inverter or the grid forming inverter with the transition to the microgrid 14A as a trigger.

In the above description, the power system operating system 20 notifies each of the plurality of switchgear units 13 of the set value of the operation condition. As described above, the power system operating system 20 can communicate with various facilities (including at least the switchgear units 13) in the power grid 10. That is, the power system operating system 20 can grasp states of the respective switchgear units 13 by communication.

Here, it is assumed that a communication failure occurs between the power system operating system 20 and the switchgear unit 13. Then, it is assumed that, for example, the frequency of power on the feeder decreases and the operation condition of the switchgear unit 13 is satisfied in the middle of the communication failure. In this case, from the viewpoint of the power system operating system 20, the power supply to the grid 14 is cut off by the switchgear unit 13 whose state has not been grasped. Therefore, the power system operating system 20 further notifies the switchgear unit 13 of a set value of the operation condition to be applied when the communication failure occurs in the embodiment. For example, in the case of the frequency, the value is lower than that in the normal state. That is, the operation condition of the switchgear unit 13 is less likely to be satisfied at the value as compared with the normal state.

When detecting the communication failure with respect to the power system operating system 20, the switchgear unit 13 switches a set value of the operation condition from that for the normal state to that for the communication failure state. As a result, it is possible to suppress the power supply cut-off by the switchgear unit 13 whose state has not been grasped by the power system operating system 20 within a certain range.

The switchgear unit 13 may calculate the set value of the operation condition for the communication failure state based on the set value of the operation condition for the normal state, instead of further receiving the set value of the operation condition of the communication failure state from the power system operating system 20. For example, in the case of the frequency, a predetermined value may be subtracted from the set value of the operation condition for the normal state to obtain the set value of the operation condition for the communication failure state.

Further, the power system operating system 20 may give up coping with the switchgear unit 13 whose state is not graspable due to the communication failure, and conversely, may set the set value of the operation condition for the communication failure state to a value at which the operation condition of the switchgear unit 13 is more likely to be satisfied as compared with the normal state. In this case, the value is higher than that of the normal state, for example, in the case of the frequency.

As described above, the switchgear unit 13 can be rationally controlled based on, for example, the priority order determined by the power purchase price without causing the system power outage when the balance of power supply and demand is lost according to the power distribution system (and the power transaction system) of the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power distribution system comprising:
a plurality of switchgear units interposed between a feeder connected to a substation and a plurality of power distribution areas; and
a power system operating system that is capable of communicating with the plurality of switchgear units and is configured to control power supply to the plurality of power distribution areas via the plurality of switchgear units, wherein
the power system operating system is configured to set any one of an allowable frequency, an allowable frequency change rate, and an allowable response time for at least two switchgear units among the plurality of switchgear units based on priority orders assigned to the plurality of power distribution areas,
each of the at least two switchgear units is configured to
cut off a power supply path between the feeder and the power distribution area when a frequency of power on the feeder falls below the allowable frequency in a case where the allowable frequency has been set,
cut off the power supply path between the feeder and the power distribution area when a frequency change rate of power on the feeder exceeds the allowable frequency change rate in a case where the allowable frequency change rate has been set, and
cut off the power supply path between the feeder and the power distribution area when an elapsed time since a state in which the power supply path between the feeder and the power distribution area is to be cut off is formed exceeds the allowable response time in a case where the allowable response time has been set,
an absolute value of a difference between the allowable frequency and a reference frequency is larger as the priority order is higher,
the allowable frequency change rate is higher as the priority order is higher, and
the allowable response time is longer as the priority order is higher.

2. A power distribution system comprising:
a plurality of switchgear units interposed between a feeder connected to a substation and a plurality of power distribution areas; and
a power system operating system that is capable of communicating with the plurality of switchgear units and is configured to control power supply to the plurality of power distribution areas via the plurality of switchgear units, wherein
the power system operating system is configured to set an allowable frequency for at least two switchgear units among the plurality of switchgear units based on priority orders assigned to the plurality of power distribution areas,
each of the at least two switchgear units is configured to cut off a power supply path between the feeder and the power distribution area when a frequency of power on the feeder exceeds the allowable frequency in a case where the allowable frequency has been set, and
an absolute value of a difference between the allowable frequency and a reference frequency is larger as the priority order is higher.

3. A power distribution system comprising:
a plurality of switchgear units interposed between a feeder connected to a substation and a plurality of power consumers; and
a power system operating system that is capable of communicating with the switchgear units and is configured to control power supply to the plurality of power consumers via the switchgear units, wherein
the power system operating system is configured to set any one of an allowable frequency, an allowable frequency change rate, and an allowable response time for at least two switchgear units among the plurality of switchgear units based on priority orders assigned to the plurality of power consumers,
each of the at least two switchgear units is configured to
cut off a power supply path between the feeder and the power consumer when a frequency of power on the feeder falls below the allowable frequency in a case where the allowable frequency has been set,
cut off the power supply path between the feeder and the power consumer when a frequency change rate of power on the feeder exceeds the allowable frequency change rate in a case where the allowable frequency change rate has been set, and
cut off the power supply path between the feeder and the power consumer when an elapsed time since a state in which the power supply path between the feeder and the power consumer is to be cut off is formed exceeds the allowable response time in a case where the allowable response time has been set,
an absolute value of a difference between the allowable frequency and a reference frequency is larger as the priority order is higher,
the allowable frequency change rate is higher as the priority order is higher, and
the allowable response time is longer as the priority order is higher.

4. A power distribution system comprising:
a plurality of switchgear units interposed between a feeder connected to a substation and a plurality of power consumers; and
a power system operating system that is capable of communicating with the plurality of switchgear units and is configured to control power supply to the plurality of power consumers via the plurality of switchgear units, wherein
the power system operating system is configured to set an allowable frequency for at least two switchgear units among the plurality of switchgear units based on priority orders assigned to the plurality of power consumers,
each of the at least two switchgear units is configured to cut off a power supply path between the feeder and the power consumer when a frequency of power on the feeder exceeds the allowable frequency in a case where the allowable frequency has been set, and
an absolute value of a difference between the allowable frequency and a reference frequency is larger as the priority order is higher.

5. The power distribution system of claim 1, further comprising a plurality of power distribution areas,
wherein, in a case where power supply between the feeder and the power distribution area is cut off by the switchgear unit, the power distribution area for which the power supply from the substation is cut off forms an off-grid.

6. A power transaction system comprising:
a control unit capable of communicating with a power consumer included in the power distribution area of the power distribution system of claim 1,
wherein the control unit is configured to set a higher power selling price to the power consumer as the priority order of the power distribution area including the power consumer is higher.

7. A power transaction system comprising:
a control unit capable of communicating with the power consumer of the power distribution system of claim 3,
wherein the control unit is configured to set a higher power selling price to the power consumer as the priority order of the power consumer is higher.

8. A power transaction system comprising:
a control unit capable of communicating with a power consumer included in the power distribution area of the power distribution system of claim 1,
wherein the control unit is configured to set a higher power purchase price from the power consumer as the priority order of the power distribution area including the power consumer is higher.

9. A power transaction system comprising:
a control unit capable of communicating with the power consumer of the power distribution system of claim 3,
wherein the control unit is configured to set a higher power purchase price from the power consumer as the priority order of the power consumer is higher.

10. The power distribution system of claim 1, wherein the priority order of the power distribution area is set to be higher as an average value of power purchase prices by power consumers included in the power distribution area is higher.

11. The power distribution system of claim 10, wherein the power system operating system is capable of communicating with a power transaction system used in a retail power market, and is configured to transmit the priority order of the power distribution area to the power transaction system.

12. The power distribution system of claim 5, wherein a power generation system or a power storage system included in the power distribution area is configured to switch a control algorithm applied to an inverter that controls power generation or power storage from a grid following inverter to a grid forming inverter, when the power distribution area forms the off-grid.

13. The power distribution system of claim 5, wherein a power generation system or a power storage system included in the power distribution area is configured to shift a control algorithm applied to an inverter that controls power generation or power storage from a state in which a virtual synchronous generator does not function to a state in which the virtual synchronous generator functions, when the power distribution area forms the off-grid.

14. The power distribution system of claim 1, wherein the switchgear unit is configured to change a set value of an operation condition when a failure occurs in communication with the power system operating system.

15. A power system operating system
capable of communicating with a plurality of switchgear units interposed between a feeder connected to a substation and a plurality of power distribution areas, and
notifying at least two switchgear units among the switchgear units of any one of an allowable frequency, an allowable frequency change rate, and an allowable response time determined based on priority orders assigned to the power distribution areas, wherein
the allowable frequency is a frequency for cutting off a power supply path between the feeder and the power distribution area when a frequency of power on the feeder falls below the allowable frequency,
the allowable frequency change rate is a frequency change rate for cutting off the power supply path between the feeder and the power distribution area when a frequency change rate of power on the feeder exceeds the allowable frequency change rate,
the allowable response time is a response time for cutting off the power supply path between the feeder and the power distribution area when an elapsed time since a state in which the power supply path between the feeder and the power distribution area is to be cut off is formed exceeds the allowable response time,
an absolute value of a difference between the allowable frequency and a reference frequency is larger as the priority order is higher,
the allowable frequency change rate is higher as the priority order is higher, and
the allowable response time is longer as the priority order is higher.

16. A power system operating system
capable of communicating with a plurality of switchgear units interposed between a feeder connected to a substation and a plurality of power distribution areas, and
notifying at least two switchgear units among the switchgear units of an allowable frequency determined based on priority orders assigned to the power distribution areas, wherein
the allowable frequency is a frequency for cutting off a power supply path between the feeder and the power distribution area when a frequency of power on the feeder exceeds the allowable frequency, and
an absolute value of a difference between the allowable frequency and a reference frequency is larger as the priority order is higher.

17. A power system operating system
capable of communicating with a plurality of switchgear units interposed between a feeder connected to a substation and a plurality of power consumers, and
notifying at least two switchgear units among the switchgear units of any one of an allowable frequency, an allowable frequency change rate, and an allowable response time determined based on priority orders assigned to the power consumers, wherein
the allowable frequency is a frequency for cutting off a power supply path between the feeder and the power consumer when a frequency of power on the feeder falls below the allowable frequency,
the allowable frequency change rate is a frequency change rate for cutting off the power supply path between the feeder and the power consumer when a frequency change rate of power on the feeder exceeds the allowable frequency change rate,
the allowable response time is a response time for cutting off the power supply path between the feeder and the power consumer when an elapsed time since a state in which the power supply path between the feeder and the power consumer is to be cut off is formed exceeds the allowable response time,
an absolute value of a difference between the allowable frequency and a reference frequency is larger as the priority order is higher,
the allowable frequency change rate is higher as the priority order is higher, and
the allowable response time is longer as the priority order is higher.

18. A power system operating system
capable of communicating with a plurality of switchgear units interposed between a feeder connected to a substation and a plurality of power consumers, and
notifying at least two switchgear units among the switchgear units of an allowable frequency determined based on priority orders assigned to the power consumers, wherein
the allowable frequency is a frequency for cutting off a power supply path between the feeder and the power consumer when a frequency of power on the feeder exceeds the allowable frequency, and
an absolute value of a difference between the allowable frequency and a reference frequency is larger as the priority order is higher.

19. The power distribution system of claim 2, further comprising a plurality of power distribution areas,
wherein, in a case where power supply between the feeder and the power distribution area is cut off by the switchgear unit, the power distribution area for which the power supply from the substation is cut off forms an off-grid.

20. A power transaction system comprising:
a control unit capable of communicating with a power consumer included in the power distribution area of the power distribution system of claim 2,
wherein the control unit is configured to set a higher power selling price to the power consumer as the priority order of the power distribution area including the power consumer is higher.

21. A power transaction system comprising:
a control unit capable of communicating with the power consumer of the power distribution system of claim 4,
wherein the control unit is configured to set a higher power selling price to the power consumer as the priority order of the power consumer is higher.

22. A power transaction system comprising:
a control unit capable of communicating with a power consumer included in the power distribution area of the power distribution system of claim 2,
wherein the control unit is configured to set a higher power purchase price from the power consumer as the priority order of the power distribution area including the power consumer is higher.

23. A power transaction system comprising:
a control unit capable of communicating with the power consumer of the power distribution system of claim 4,
wherein the control unit is configured to set a higher power purchase price from the power consumer as the priority order of the power consumer is higher.

24. The power distribution system of claim 2, wherein the priority order of the power distribution area is set to be higher as an average value of power purchase prices by power consumers included in the power distribution area is higher.

25. The power distribution system of claim 19, wherein a power generation system or a power storage system included in the power distribution area is configured to switch a control algorithm applied to an inverter that controls power generation or power storage from a grid following inverter to a grid forming inverter, when the power distribution area forms the off-grid.

26. The power distribution system of claim 19, wherein a power generation system or a power storage system included in the power distribution area is configured to shift a control algorithm applied to an inverter that controls power generation or power storage from a state in which a virtual synchronous generator does not function to a state in which the virtual synchronous generator functions, when the power distribution area forms the off-grid.

27. The power distribution system of claim 2, wherein the switchgear unit is configured to change a set value of an operation condition when a failure occurs in communication with the power system operating system.

28. The power distribution system of claim 3, wherein the switchgear unit is configured to change a set value of an operation condition when a failure occurs in communication with the power system operating system.

29. The power distribution system of claim 4, wherein the switchgear unit is configured to change a set value of an operation condition when a failure occurs in communication with the power system operating system.
